(19) United States
(12) Patent Application Publication
(10) Pub. No.: US 2008/0129501 A1
(43) Pub. Date: Jun. 5, 2008

(54) SECURE CHASSIS WITH INTEGRATED TAMPER DETECTION SENSOR

(75) Inventors: James L. Tucker, Clearwater, FL (US); William J. Dalzell, Parrish, FL (US); Scott G. Fleischman, Palmetto, FL (US); Kenneth H. Heffner, Largo, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/565,376

(22) Filed: Nov. 30, 2006

(51) Int. Cl. G08B 13/00

(52) U.S. Cl. 340/550

(57) ABSTRACT

A secure chassis comprises a plurality of walls, wherein each wall comprises an inner portion; an outer portion; and a tamper sensor disposed between the inner portion and the outer portion of each wall, the tamper sensor configured to detect unauthorized tamper events; wherein the plurality of walls are coupled together to form an enclosure to house one or more components.

### CROSS-REFERENCE TO RELATED APPLICATIONS

This application is related to co-pending U.S. patent application Ser. No. ______, filed on ______ entitled “SECURE CONNECTOR WITH INTEGRATED TAMPER SENSORS”, attorney docket number H0012757-5809, hereby incorporated herein by reference, and referred to herein as the “'12757 Application”.

This application is related to co-pending U.S. patent application Ser. No. ______, filed on ______, entitled “CARD SLOT ANTI-TAMPER PROTECTION”, attorney docket number H0013121-5809, hereby incorporated herein by reference, and referred to herein as the “'13121 Application”.

### BACKGROUND

Electronics systems and products containing proprietary information are subject to the risk of unauthorized examination at all levels of assembly including a closed chassis. A broad range of reverse engineering methods can be applied to obtaining unauthorized access to the confidential internal workings, data, etc. inside such a chassis. Such methods include removing access panels, drilling, or other means of gaining access to the proprietary information residing inside the chassis.

Protective methods and apparatus are used to delay the success of such reverse engineering attempts. However, given the necessary resources and time, these methods can be defeated. A known, successful reverse engineering attack renders the protective method or apparatus vulnerable to future attacks, and thereby ends the usefulness. New methods and apparatus are, therefore, needed to detect and/or thwart reverse engineering attacks on systems with proprietary property.

### SUMMARY

In one embodiment, a secure chassis is provided. The secure chassis comprises a plurality of walls, wherein each wall comprises an inner portion; an outer portion; and a tamper sensor disposed between the inner portion and the outer portion of each wall, the tamper sensor configured to detect unauthorized tamper events; wherein the plurality of walls are coupled together to form an enclosure to house one or more components.

### DRAWINGS

The present invention can be more easily understood and further advantages and uses thereof more readily apparent, when considered in view of the description of the following figures in which:

FIG. 1 is an elevated perspective view depicting a system having a secure chassis according to one embodiment of the present invention.

FIG. 2 is a cross-sectional side view depicting a secure chassis coupled to a secure connector according to another embodiment of the present invention.

Like reference numbers and designations in the various drawings indicate like elements.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that mechanical and electrical changes may be made without departing from the scope of the present invention. The following detailed description is, therefore, not to be taken in a limiting sense.

Embodiments of the present invention enable the detection of unauthorized attempts to gain access (e.g. tamper events) to the inside of a secure chassis. For example, embodiments of the present invention detect attempts to drill through a chassis, remove a chassis lid, etc. In addition, to detecting tamper events, embodiments of the present invention allow easy handling and assembling of a chassis system by preventing the tamper sensors from interfering with the placement of components inside a secure chassis.

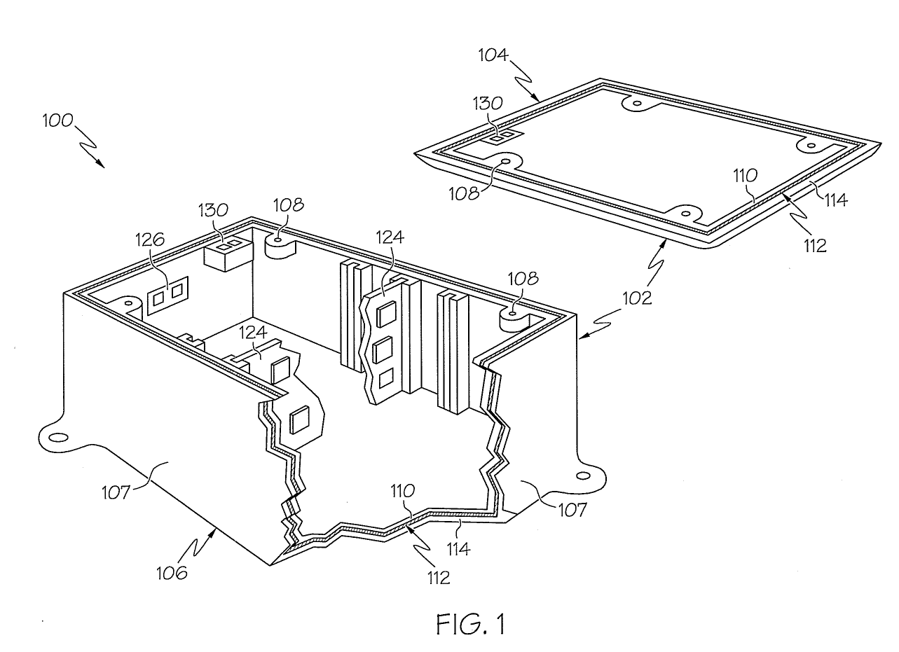

FIG. 1 is an elevated perspective view depicting a system 100 having a secure chassis 102 according to one embodiment of the present invention. Chassis 102 is comprised of a plurality of exterior walls. As used herein, the term “exterior wall” refers to a wall in system 100 that is not surrounded or enclosed by other walls in system 100. In particular, in the embodiment shown in FIG. 1, chassis 102 is comprised of lid 104 and container 106. Container 106 is a continuous wall in this example which forms a base 105 having a plurality of sides 107. Lid 104 is configured to couple to sides 107 of container 106 to form a sealed enclosure. Although sides 107 are formed by one wall in this example, embodiments of the present invention are not so limited. For example, in other embodiments, each of sides 107 and base 105 is formed by a separate individual wall, the sides 107 and base 105 being coupled together to form container 106. Each of sides 107, base 105, and lid 104 can also be referred to as an exterior wall, as used herein.

In addition, it is to be understood that, although chassis 102 is shown as rectangular in FIG. 1, other shapes and configurations of chassis 102 can be used in other embodiments. For example, in other embodiments, chassis 102 is cylindrical. In one such embodiment, a cylindrical wall is coupled to a base and lid for sealing each end of the hollow cylindrical wall.

In the embodiment in FIG. 1, sides 107 of container 106 and lid 104 are coupled together with a plurality of mounting holes 108. However, it is to be understood that other means of coupling lid 104 to sides 107 are used in other embodiments. For example, in one other embodiment, sides 107 and lid 104 are welded together using welding techniques known to one of skill in the art.

Each of sides 107, base 105 and lid 104 comprise an outer portion 114, an inner portion 110, and a tamper sensor 112. Inner portion 110 and outer portion 114 are made of any appropriate material for the application in which chassis 102 is to be used. For example, suitable materials include, but are not limited to, composite materials (such as fiber reinforced polymers, metal alloys, etc.), metals (such as iron, lead, etc.), and ceramic materials (such as boron carbide, alumina, ceramic metal composites (cermets), etc.). Criteria upon which the material can be selected includes, but is not limited to, stress resistance of the material, ability of the material to prevent x-radiation or infrared detection, cost of the material, ease of manufacture of the material, etc.

Container 106 and lid 104 form a secure sealed enclosure for housing various components. Components that can be housed inside chassis 102 include but are not limited to, volatile and non-volatile data storage devices, such as dynamic random access memory (DRAM) or electrically erasable programmable ROM (EEPROM), processing units, and other controllers, etc. For example, in FIG. 1, circuit card 124, which holds sensitive data in this example, is located inside chassis 102. A reverse engineer may attempt to access the components, such as circuit card 124, to extract the sensitive data or examine the components themselves. Chassis 102, however, provides a deterrent to such unauthorized access by detecting unauthorized attempts to access the inside of chassis 102. In particular, tamper sensor 112 is configured to detect unauthorized tamper events and is disposed between inner portion 110 and outer portion 114 throughout each of walls 104 and 106.

Unauthorized tamper events include, but are not limited to, removing access panels, drilling, or other means of gaining access to sensitive equipment or electronic components inside chassis 102. For example, in some embodiments, tamper sensor 112 is a fiber optic matrix which is configured to detect interference with the light traveling through the fiber optic matrix. In such embodiments, drilling through the fiber optic matrix, for example, will disrupt the light in the fiber optic matrix. The disruption will trigger a detected tamper event. In other embodiments, tamper sensor 112 is an electrical sensor configured to detect changes in electrical properties, e.g. resistance, due to unauthorized tamper events such as excessive pressure on or puncturing of tamper sensor 112. It is to be understood that tamper sensor 112 can be implemented as any appropriate type of sensor configured to detect unauthorized tamper events.

Coupled to tamper sensor 112 is monitoring coupler 126. Monitoring coupler 126 couples the tamper sensor 112 in container 106 and/or lid 104 to a monitoring device 128. Monitoring device 128 monitors tamper sensor 112 for any detected tamper events. If a tamper event is detected, monitoring device 128 controls a response to protect sensitive data. For example, monitoring device 128 can erase sensitive data, encrypt sensitive data, or physically destroy components holding the sensitive data, such as circuit card 124.

In addition, in some embodiments, tamper sensor 112 in container 106 is coupled to tamper sensor 112 in lid 104 via a coupler 130. For example, coupler 130 can include, but is not limited to, a mechanical optocoupler or a fusion of the termini of two optical fibers extending from tamper sensors 112 in lid 104 and container 106. Coupler 130 enables the tamper sensors to function together rather than separately. Therefore, a detected tamper event by tamper sensor 112 in either container 106 or lid 104 will trigger a response by monitoring device 128 without requiring that both tamper sensors 112 be individually coupled to monitoring device 128. In embodiments having separate walls for each of sides 107, a coupler 130 can be used to couple tamper sensor 112 in each of the plurality of sides 107 to at least one other tamper sensor 112. Furthermore, in some embodiments, mounting holes 108 are coupled to tamper sensor 112 in container 106 and/or lid 104 such that a forced removal of lid 104 from container 106 will cause tamper sensors 112 to detect the forced removal.

Embodiments of the present invention, therefore, enhance security of sensitive data by providing tamper sensor 112 throughout a perimeter of chassis 102 to detect unauthorized attempts to gain access to the inside of chassis 102. In addition, by placing tamper sensor 112 between inner portion 110 and outer portion 114 of each of container 106 and lid 104, visibility of tamper sensor 112 is minimized. This enhances the probability that tamper sensor 112 will detect an unauthorized tamper event because reverse engineers are less likely to attempt to circumvent tamper sensor 112 since it is hidden from their view.

In addition, embodiments of the present invention improve efficiency of handling and assembling system 100. For example, during assembly, chassis 102 is essentially handled as a conventional non-secure chassis since tamper sensor 112 does not interfere with the placement of other components inside of chassis 102, such as circuit card 124. Tamper sensor 112 does not interfere with the placement of other components because tamper sensor 112 is located between inner portion 110 and outer portion 114 rather than inside the enclosure of chassis 102 with the other components.

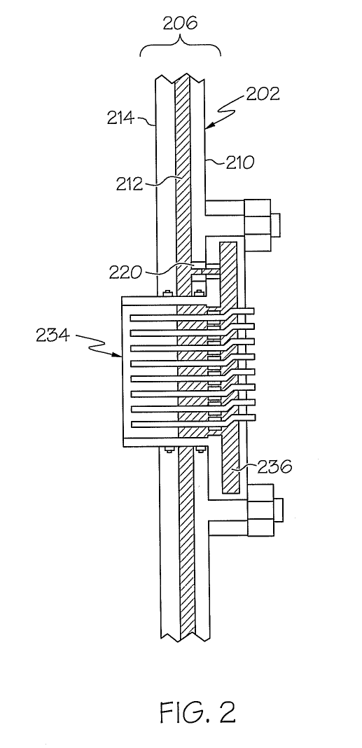

FIG. 2 is a cross-sectional side view depicting a portion of a container 206 of a secure chassis 202 coupled with a secure connector 234 according to another embodiment of the present invention. A description of a secure connector is provided in co-pending U.S. patent application Ser. No. ______, (attorney docket no. H0012757-5809) filed on even date with the present application and incorporated herein by reference. In particular, secure connector 234 includes a tamper sensor 236 disposed inside a casing 238 of secure connector 234. As shown in FIG. 2, container 206 of chassis 202 comprises inner portion 210, tamper sensor 212, and outer portion 214. Container 206 is configured with connection point 220 which couples tamper sensor 212 to tamper sensor 236 in secure connector 234. For example, connection point 220 can include, but is not limited to, a mechanical optocoupler or a fusion of the termini of two optical fibers extending from tamper sensors 212 and 236. In this example, continuity is provided between tamper sensors 212 and 236 via contact 220. This continuity increases the security provided by connector 234 and chassis 202 by eliminating a potential gap in detection which could be exploited by a reverse engineer.

A tamper event detected by either tamper sensor 212 or tamper sensor 236 causes a monitoring device (such as monitoring device 128) to control a response to the detected tamper event. Although, chassis 202 is used with secure connector 236 in this embodiment, it is to be understood that chassis 202 can be used with any type of connector in other embodiments. In particular, chassis 202 can be used with conventional non-secure connectors instead of secure connector 234.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A secure chassis, comprising:
a plurality of exterior walls, wherein each exterior wall comprises:
an inner portion;
an outer portion; and
a tamper sensor disposed between the inner portion and the outer portion of each exterior wall, the tamper sensor configured to detect unauthorized tamper events;
wherein the plurality of exterior walls are coupled together to form an enclosure to house one or more components.

2. The secure chassis of claim 1, wherein the tamper sensor comprises a fiber optic matrix.

3. The secure chassis of claim 1, wherein, the tamper sensor comprises an electrical sensor configured to detect changes in electrical characteristics.

4. The secure chassis of claim 1, wherein the inner portion and outer portion of each exterior wall are comprised of a composite material, a metal, or a ceramic material.

5. The secure chassis of claim 1, further comprising a connection point configured to couple the tamper sensor to a tamper sensor in a secure connector.

6. The secure chassis of claim 1, further comprising at least one coupler configured to couple the tamper sensor in one of the plurality of walls to the tamper sensor in another of the plurality of exterior walls.

7. The secure chassis of claim 1, wherein the plurality of exterior walls comprise a container including a base and a plurality of sides, and a lid which is coupleable to the plurality of sides to form a sealed enclosure.

8. The secure chassis of claim 7, wherein the lid and the plurality of sides of the container are coupled together via a plurality of mounting holes.

9. The secure chassis of claim 8, wherein the mounting holes are coupled to the tamper sensor in the lid or the container such that forced removal of the lid from the sides of the container is detected by the tamper sensor.

10. A secure system comprising:
a secure chassis, comprising:
a container including a base and a plurality of sides; and
a lid coupled to the plurality of sides to form a sealed enclosure, wherein the lid and the container each comprise:
an inner portion;
an outer portion; and
a tamper sensor disposed between the inner portion and the outer portion, the tamper sensor configured to detect unauthorized tamper events;
one or more secure connectors each including a tamper sensor disposed inside a casing;
one or more sensitive components disposed in the sealed enclosure; and
a monitoring device coupled to the one or more sensitive components and to a tamper sensor in the lid or the container, wherein the monitoring device is configured to control a response to unauthorized tamper events detected by the tamper sensor.

11. The secure system of claim 10, wherein the tamper sensor comprises a fiber optic matrix.

12. The secure system of claim 10, wherein, the tamper sensor comprises an electrical sensor configured to detect changes in electrical characteristics.

13. The secure system of claim 10, wherein the inner portion and outer portion of the lid and the container are each comprised of a composite material, a metal, or a ceramic material.

14. The secure system of claim 10, wherein the secure chassis further comprises a connection point configured to couple the tamper sensor in the container to the tamper sensor in the one or more secure connectors.

15. The secure system of claim 10, further comprising at least one coupler configured to couple the tamper sensor in the lid to the tamper sensor in the container.

16. The secure system of claim 10, wherein the monitoring device is configured to control a response comprising encryption of data on the one or more sensitive components, erasure of data on the one or more sensitive components, or physical destruction of the one or more sensitive components.

17. The secure system of claim 10, wherein the lid is coupled to the plurality of sides of the container via a plurality of mounting holes.

18. The secure system of claim 17, wherein the mounting holes are coupled to the tamper sensor in the lid or the container such that forced removal of the lid from the plurality of sides of the container is detected by the tamper sensor.

19. A secure chassis comprising:
a container including a base and a plurality of sides;
a lid configured to couple to the plurality of sides to form a sealed enclosure for one or more sensitive components, wherein the lid and the container each comprise:
an inner portion;
an outer portion; and
a tamper sensor disposed between the inner portion and the outer portion, the tamper sensor configured to detect unauthorized tamper events; and
a coupler configured to couple the tamper sensor in the lid to the tamper sensor in the container.

20. The secure chassis of claim 19, wherein the tamper sensor in the lid and the tamper sensor in the container each comprise a fiber optic matrix or an electrical sensor configured to detect changes in electrical characteristics.
